(19) United States
(12) Patent Application Publication
(10) Pub. No.: US 2014/0035536 A1
(43) Pub. Date: Feb. 6, 2014

(54) Activation Device for Use on Intelligent Battery

(71) Applicant: TIANJIN CHANGHE TECHNOLOGY CO. LTD., Tianjin (CN)

(72) Inventor: Changhe Fan, Tianjin (CN)

(73) Assignee: TIANJIN CHANGHE TECHNOLOGY CO. LTD., Tianjin (CN)

(21) Appl. No.: 14/043,729

(22) Filed: Oct. 1, 2013

Related U.S. Application Data
(63) Continuation of application No. PCT/CN2012/076243, filed on May 29, 2012.

(30) Foreign Application Priority Data
May 17, 2012 (CN) CN201220224061/2

(51) Int. Cl. H02J 7/00

(52) U.S. Cl. CPC H02J 7/0052
USPC 320/157

(57) ABSTRACT

This utility model releases an activation device for use on intelligent battery, which includes: main control circuit, and the said main control circuit is connected to charging time control circuit via the primary control signal, to the output voltage control circuit via the secondary control signal, to the charging status control circuit via the tertiary and quaternary, to the pulse control circuit via the quinary control signal and to the power supply circuit via the 14V voltage signal. The activation device makes improvements on basis of normal chargers, has simple circuit design and is easy to use and free of influence of cold weather conditions; in addition, it can also protect the battery from oxidation and activate the battery.

### CROSS-REFERENCE TO RELATED APPLICATION

The application is a continuation of PCT/CN2012/076243 (filed on May 29,2012), which claims priority of Chinese patent application 201220224061.2 (filed on May 17,20 12), the contents of which are incorporated herein by reference.

### FIELD OF THE INVENTION

This utility model involves intelligent batteries, especially an activation device for use on intelligent batteries.

### BACKGROUND OF THE INVENTION

As a clean and green energy source, accumulator battery has been extensively applied, especially it has an important position in the fields of electric automobile. The electric automobile industry rose in China only several years ago, however, in such short period, electric automobile industry has achieved high growth rate and significant development, in which the accumulator battery plays a critical role.

During the embodiment of this utility model, it is found that the existing technologies have the following disadvantages and defects:

During winters, attenuation will occur to accumulator batteries, resulting in abnormal charging and adverse influence to the normal functioning of the vehicle.

### BRIEF DESCRIPTION OF THE DRAWINGS

FIG. 1 shows the structure diagram of an activation device for use on intelligent battery provided by this utility model;

FIG. 2 shows the schematic diagram of the main control circuit provided by this utility model;

FIG. 3 shows the schematic diagram of the charging time control circuit provided by this utility model;

FIG. 4 shows the schematic diagram of the output voltage control circuit provided by this utility model;

FIG. 5 shows the schematic diagram of the charging status control circuit provided by this utility model;

FIG. 6 shows the schematic diagram of the pulse control circuit provided by this utility model;

FIG. 7 shows the schematic diagram of the power supply circuit provided by this utility model;

The numbers shown on the such drawings represents the following parts:

SJ_CON: the primary control signal;

RP_CTR: the secondary control signal;

LED1: the tertiary control signal;

LED2: the quaternary control signal;

PULS: the quinary control signal;

R43: the primary resistor;

R42: the secondary resistor;

R47: the third resistor;

R41: the fourth resistor;

R44: the fifth resistor;

R45: the primary divider resistor;

R40L: the secondary divider resistor;

K2: the primary relay

K1: the secondary relay;

T8: the primary triode;

T5: the secondary triode;

T6: the third triode;

T7: the fourth triode;

D20: the primary diode;

D22: the second diode;

J1: digital display tube;

U1: SCM;

J2: control signal output;

LG1: force charging indicating light;

T4: the primary stabilivolt;

VCC: power supply;

C21: filter capacitor;

LG: the primary LED;

LR: the secondary LED.

### DETAILED DESCRIPTION OF THE INVENTION

This utility model provides an activation device for use on batteries and it can avoid the attenuation phenomena, so that the accumulator battery can work normally even in cold situations, as described below:

An activation device for use on intelligent battery, which includes: main control circuit which is connected to charging time control circuit via the primary control signal, to the output voltage control circuit via the secondary control signal, to the charging status control circuit via the tertiary and quaternary control signals, to the pulse control circuit via the quinary control signal and to the power supply circuit via the 14V voltage signal.

The said main control circuit includes: digital display tube which is connected to a SCM; the said primary control signal generated by the said SCM is connected to the said charge time control circuit via the control signal output interface; the said secondary control signal is connected to the said output voltage control circuit via the said control signal output interface; the said tertiary control signal and the said quaternary signal are connected to the said charging status control circuit via the said control signal output interface; the said quinary control signal is connected to the said pulse control circuit via the said control signal output interface; the said 14V voltage signal is connected to the said power supply circuit via the said control signal output interface.

The said SCM model is 89C2051A; the said digital display tube is a 8-band digital display tube.

The said charging time control circuit includes: the primary resistor, of which one end is connected to the said primary control signal from the said main control circuit and the other end is connected to the base of the primary triode, of which the collector is grounded and the emitter is connected to an end of the secondary resistor; the other end of the said secondary resistor is connected, at a same time, to the anode of the primary diode and the fourth end of the primary relay, and the cathode of such said diode is connected to the fifth end of the primary relay.

The said output voltage control circuit includes: the tertiary resistor, of which one end is connected to the said secondary control signal from the said main control circuit and the other end is connected to the base of the secondary triode, of which the collector is grounded and the emitter is connected to the fourth end of the secondary relay; the third end of the said secondary relay is connected to an end of the fourth resistor, while the other end of the fourth resistor is connected to the primary end of the said secondary relay.

The said charging control circuit includes: the primary LED and the secondary LED; the anode of the said primary LED is connected to the said tertiary control signal from the said main control circuit and the anode of the said secondary LED is connected to the quaternary control signal from the said main control circuit, and the cathodes of the said primary and secondary LEDs are grounded.

The said pulse control circuit includes: the fifth resistor, of which one end is connected to the said quinary control signal from the said main control circuit and the other end is connected to the base of the tertiary triode, of which the emitter is connected to the divider resistor, the collector is connected to the base of the fourth triode and the collector of the fourth triode is connected to the secondary diode.

The said power supply circuit includes: the secondary divider resistor, of which one end is connected to the said 14V voltage signal and the other end is connected to the input end of the primary stabilivolt; the output end of such said primary stabilivolt is connected, at a same time, to the power supply VCC and the positive electrode of a filter capacitor and the negative electrode of such said filter capacitor is grounded.

This utility model provides an activation device for use on intelligent batteries, which can realized the following benefits; the activation device makes improvement on basis of normal chargers, has simple circuit design and is easy to use and free of influence of cold weather conditions; in addition, it can also protect the battery from oxidation and activate the battery.

The embodiment of this utility model is further illustrated in details with help of drawings, in order to clarify the purpose, technical solution and advantages of this utility model.

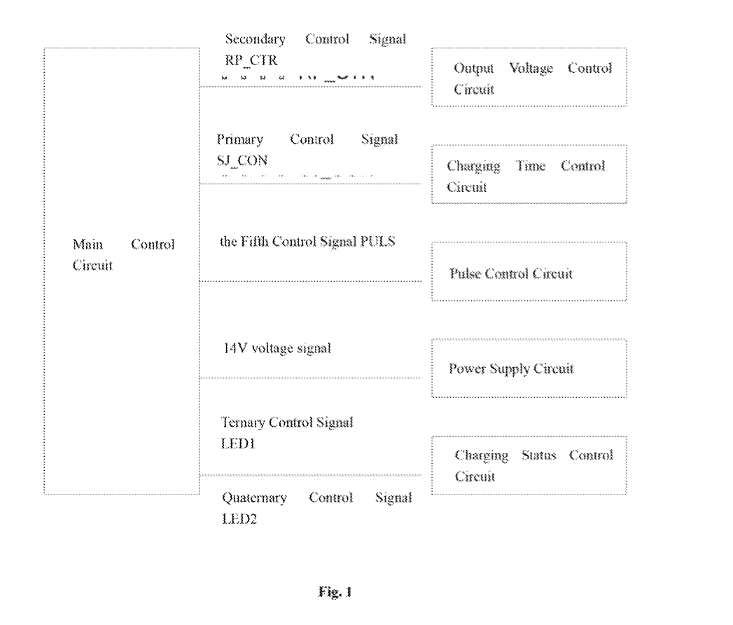

In order to avoid the attenuation and in order that the battery can work normally in cold situations, this utility model provides an activation device fur use on intelligent batteries, as shown in FIG 1, which is described as follows:

As shown in FIG. 1, an activation device for use on intelligent battery, which includes: main control circuit which is connected to charging time control circuit via the primary control signal SJ_CON, to the output voltage control circuit via the secondary control signal RP_CTR, to the charging status control circuit via the tertiary LED1 and quaternary LED2 control signals, to the pulse control circuit via the quinary control signal PULS and to the power supply circuit via the 14V voltage signal.

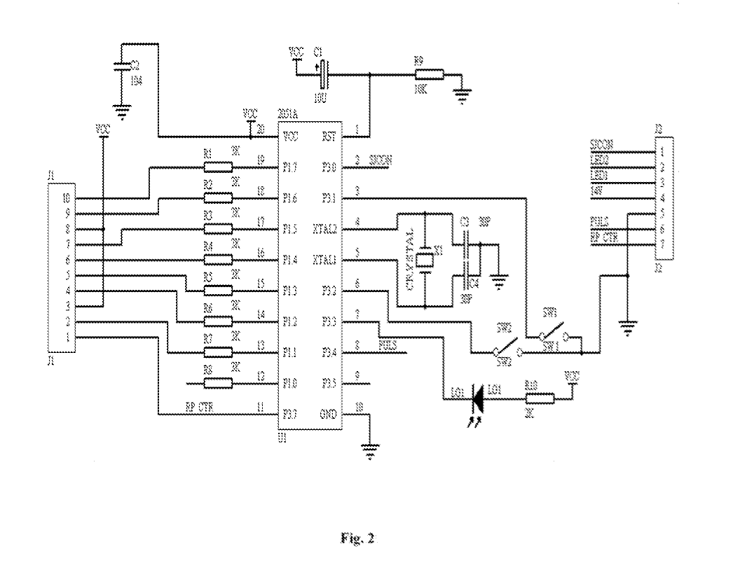

As shown in FIG. 2, the main control circuit includes: digital display tube J1 which is connected to SCM U1; the primary control signal SJ_CON generated on the SCM U1 is connected to the charging time control circuit via the control signal output interface J2; the secondary control signal RP_STR is connected to the output voltage control circuit via the control signal output interface; the tertiary control signal LED1 and the quaternary control signal LED2 are connected to the charging status control circuit via the control signal output interface; the quinary control signal PULS is connected to pulse control circuit via the control signal output interface J2 to control the on/off status of indicating light LG1; 14V voltage signal is connected to the power supply circuit via the control signal output interface J2.

In this utility model, when it is embodied, the model of SCM U1 is 89C2051A and the digital display tube J1 is a 8-band digital display tube.

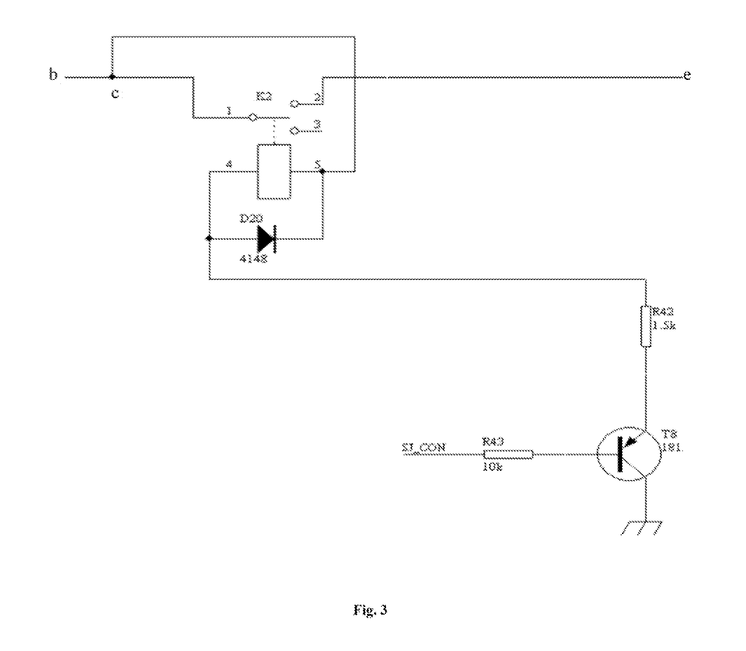

As shown in FIG. 3, the charging time control circuit includes: the primary resistor R43, of which one end is connected to the primary control signal SJ_CON from the main control circuit and the other end is connected to the base of the primary triode T8, of which the collector is grounded and the emitter is connected to an end of the secondary resistor R42; the other end of the said secondary resistor R42 is connected, at a same time, to the anode of the primary diode D20 and the fourth end of the primary relay K2, and the cathode of such diode D20 is connected to the fifth end of the primary relay K2.

In this utility model, the primary control signal SJ_CON is input via the primary resistor R43 to control the through/off of primary triode T8, so that it can control the open/close of the primary relay K2 and control the charging time. In such a manner, the charging time will be as long as 6 hours, and it can accurately control the charging time and avoid adverse influence on the battery.

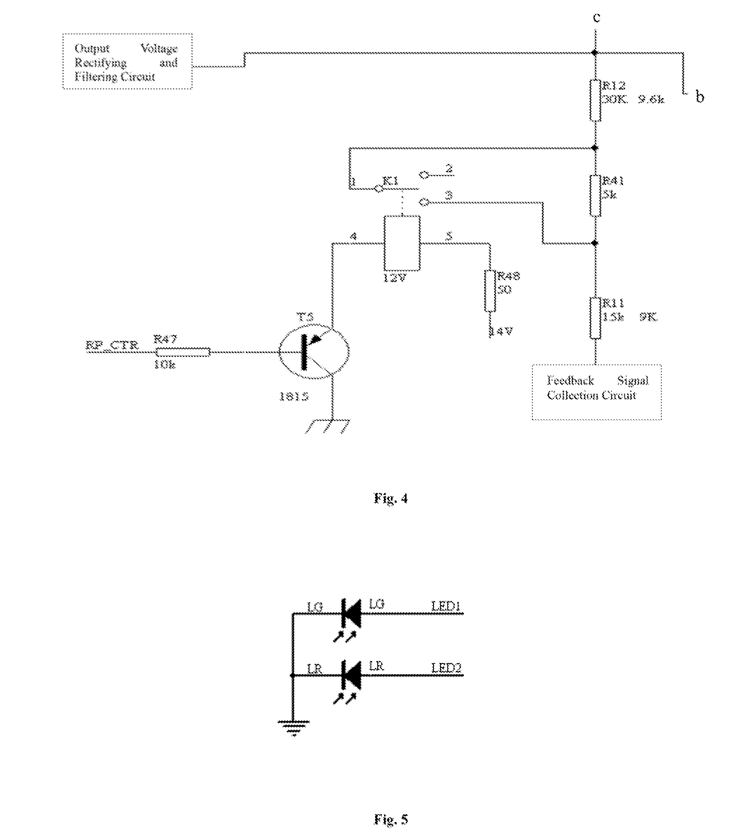

As shown in FIG. 4, the output voltage control circuit includes: the tertiary resistor R47, of which one end is connected to the said secondary control signal RP_CTR from the said main control circuit and the other end is connected to the base of the secondary triode T5, of which the collector is grounded and the emitter is connected to the fourth end of the secondary relay K1; the third end of the secondary relay K1 is connected to an end of the fourth resistor R41, while the other end of the fourth resistor R41 is connected to the primary end of the secondary relay K1.

In this utility model, one end of the third resistor R41 is connected to the feedback signal collection circuit via a resistor R11; the feedback signal collection circuit is a general purpose in the current tertiary and is not described herein.

In this utility model, the other end of the third resistor R41 is connected to the output voltage rectifying and filtering circuit via a resistor R12; the output voltage rectifying and filtering circuit is a general purpose in the current tertiary and is not described here.

In this utility model, the secondary control signal RP_CTR is input via the third resistor R47, to control the through/off of the secondary triode T5, and to further control the open/close of the secondary relay K1. When the secondary relay K1 is connected to the third end and the fourth resistor R41 is isolated, the battery will be normally charged; when the secondary relay K1 is connected to the second end and the fourth resistor R41 is put through, it will control the feedback signal and control the output voltage. It can realize force charging to the battery, so as to avoid attenuation and ensure that the battery operates properly.

As shown in FIG. 5, the charging control circuit includes: the primary LED LG and the secondary LED LR; the anode of the primary LED LG is connected to the tertiary control signal LED1 from the main control circuit and the anode of the secondary LED LR is connected to the quaternary control signal LED2 from the said main control circuit, and the cathodes of the primary LG and secondary LR LEDs are grounded.

In this utility model, the primary LED LG and the secondary LED ER are charging status indicating lights and are controlled by signals from the main control circuit. During the charging process, the secondary LED LR is on and when the charging is stopped, the primary LED LG is on.

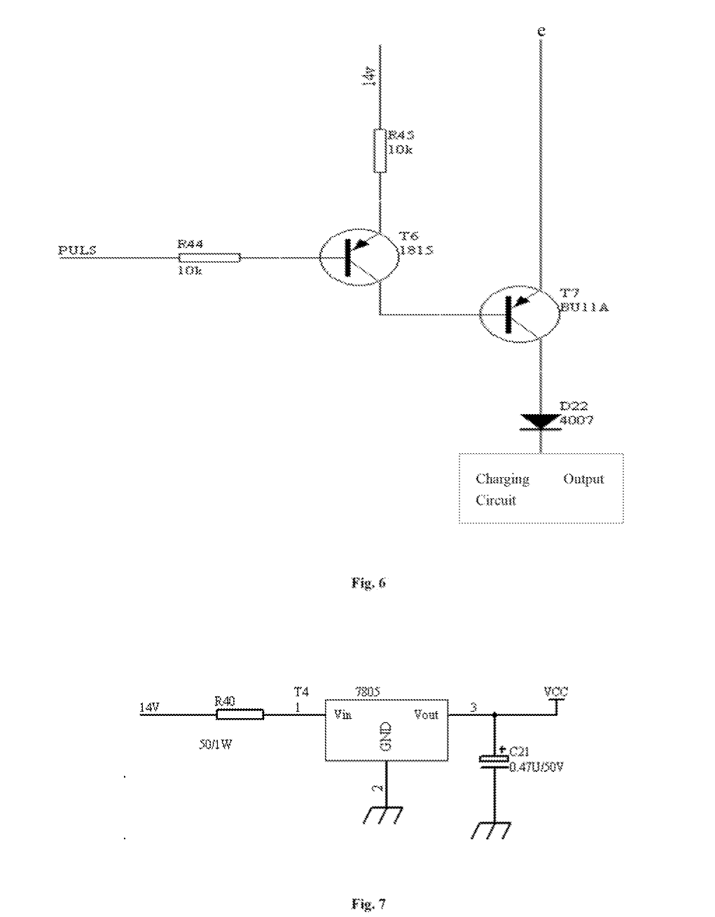

As shown in FIG. 6, the pulse control circuit includes: the fifth resistor R44, of which one end is connected to the fifth control signal PULS from the said main control circuit and the other end is connected to the base of the tertiary triode T6, of which the emitter is connected to the divider resistor R45, the collector is connected to the base of the fourth triode T7 and the collector of the fourth triode is connected to the secondary diode D22.

In this utility model, the fifth control signal PULS is input via the fifth resistor R44 and generates pulse current after amplified by the third triode T6 and the fourth triode T7. With this circuit, the third triode T6 and the fourth triode T7 are put through to generate instantaneous direct current, so as to protect the battery from oxidation and to activate the battery.

In this utility, the secondary diode D22 is connected to the output circuit of the charger which adopts a general purpose circuit in the existing technology and is not described herein.

As shown in FIG. 7, the power supply circuit includes: the secondary divider resistor R40, of which one end is connected to the said 14V voltage signal and the other end is connected to the input end of the primary stabilivolt T4; the output end of such primary stabilivolt T4 is connected, at a same time, to the power supply VCC and the positive electrode of a filter capacitor C21 and the negative electrode of such filter capacitor C21 is grounded.

In this system, the embodiment example of this utility model does not have any restrictions on the models of above-mentioned components and in the real embodiment, the utility model will not have any restrictions either.

In all, this utility model provides an activation device for use on intelligent batteries, which makes improvement on basis of normal chargers, has simple circuit design and is easy to use and free of influence of cold weather conditions, in addition, it can also protect the battery from oxidation and activate the battery.

Technical persons in this area can understand that the drawing attached works only as a preferred embodiment example and the numbers in the above utility model embodiment example are only for description purpose and do not stand for the advantages or disadvantages of the embodiment example.

The description above is only a relatively favorable embodiment example of this utility model and constitutes no limitation on such utility model. All modifications, equivalent substitution and improvements under the guideline and principles of this utility model are covered in the protection range of this utility model.

1. An activation device for use on intelligent battery, which includes: main control circuit which is characterized by that the said main control circuit is connected to charging time control circuit via the primary control signal, to the output voltage control circuit via the secondary control signal, to the charging status control circuit via the tertiary and quaternary, to the pulse control circuit via the quinary control signal and to the power supply circuit via the 14V voltage signal.

2. According to claim 1 above, an activation device for use on intelligent battery, which is characterized by that the said main control circuit includes: digital display tube which is connected to a SCM; the said primary control signal generated by the said SCM is connected to the said charge time control circuit via the control signal output interface; the said secondary control signal is connected to the said output voltage control circuit via the said control signal output interface; the said tertiary control signal and the said quaternary signal are connected to the said charging status control circuit via the said control signal output interface; the said quinary control signal is connected to the said pulse control circuit via the said control signal output interface; the said 14V voltage signal is connected to the said power supply circuit via the said control signal output interface.

3. According to claim 2 above, an activation device tom use on intelligent battery, which characterized by that the said SCM is 89C2051A type, and the said digital display tube is a 8-band digital display tube.

4. According to claim 1 above, an activation device for use on intelligent battery, which is characterized by that the said charging time control circuit includes: the primary resistor, of which one end is connected to the said primary control signal from the said main control circuit and the other end is connected to the base of the primary triode, of which the collector is grounded and the emitter is connected to an end of the secondary resistor; the other end of the said secondary resistor is connected, at a same time, to the anode of the primary diode and the Iburth end of the primary relay, and the cathode of such said diode is connected to the fifth end of the primary relay.

5. According to claim 1 above, an activation device for use on intelligent battery, which is characterized by that the said output voltage control circuit includes: the tertiary resistor, of which one end is connected to the said secondary control signal from the said main control circuit and the other end is connected to the base of the secondary triode, of which the collector is grounded and the emitter is connected to the fourth end of the secondary relay; the thud end of the said secondary relay is connected to an end of the fourth resistor, while the other end of the fourth resistor is connected to the primary end of the said secondary relay.

6. According to claim 1 above, an activation device let use on intelligent battery, which is characterized by that the said chanting control circuit includes: the primary LED and the secondary LED; the anode of the said primary LED is connected to the said tertiary control signal from the said main control circuit and the anode of the said secondary LED is connected to the quaternary control signal from the said main control circuit, and the cathodes of the said primary and secondary LEDs are grounded.

7. According to claim 1, an activation device for use on intelligent battery, which is characterized by that the said pulse control circuit includes: the fifth resistor, of which one end is connected to the said quinary control signal from the said main control circuit and the other end is connected to the base of the tertiary triode, of which the emitter is connected to the divider resistor, the collector is connected to the base of the fourth triode and the collector of the fourth triode is connected to the secondary diode.

8. According to claim 1 above, an activation device for use on intelligent battery, which is characterized by that the said power supply circuit includes: the secondary divider resistor, of which one end is connected to the said 14V voltage signal and the other end is connected to the input end of the primary stabilivolt; the output end of such said primary stabilivolt is connected, at a same time, to the power supply VCC and the positive electrode of a filter capacitor and the negative electrode of such said filter capacitor is grounded.
